(19) United States
(12) Patent Application Publication
(10) Pub. No.: US 2024/0123785 A1
(43) Pub. Date: Apr. 18, 2024

(54) Joint Assembly

(71) Applicants: Troy A. Carter, Sunnyvale, CA (US); Daniel Thomas Harsh, Holland, MI (US); Joshua Edward Cook, Grand Junction, MI (US)

(72) Inventors: Troy A. Carter, Sunnyvale, CA (US); Daniel Thomas Harsh, Holland, MI (US); Joshua Edward Cook, Grand Junction, MI (US)

(21) Appl. No.: 17/964,475

(22) Filed: Oct. 12, 2022

(51) Int. Cl. B60G 11/24

(52) U.S. Cl. CPC B60G 11/24; B60G 2202/143; B60G 2204/125; B60G 2204/41; B60G 2206/42; B60G 2800/162

(57) ABSTRACT

A joint assembly couples a linear actuator to a body. The joint assembly includes a first body having a first surface and a second body having a second surface. The first body is coupled with the second body. The first surface and the second surface have arcuate configurations that are complementary to facilitate rotation of the first body relative to the second body about a first axis, a second axis, orthogonal to the first axis, and a third axis, orthogonal to both the first axis and the second axis. The joint assembly also includes a damper disposed between the first body and the second body and configured to dampen translational motion of the first body toward the second body in response to movement of the linear actuator relative to the body.

### TECHNICAL FIELD

This disclosure relates generally to the field of joint assemblies.

### BACKGROUND

Vehicles include components that require articulation. One example is a suspension assembly that allows movement of wheels relative to a body of the vehicle. Some suspension assemblies utilize a joint assembly to couple a linear suspension actuator to the body to facilitate rotation therebetween.

### SUMMARY

One aspect of the disclosure is a joint assembly for coupling a linear suspension actuator to a body of a vehicle. The joint assembly includes a first body having a first surface and configured to be fixed to one of the linear suspension actuator or the body and a second body having a second surface and configured to be fixed to the other one of the linear suspension actuator or the body. The first body is coupled with the second body. The first surface and the second surface have arcuate configurations that are complementary to facilitate rotation of the first body relative to the second body about a first axis, a second axis, orthogonal to the first axis, and a third axis, orthogonal to both the first axis and the second axis. The joint assembly also includes a damper disposed between the first body and the second body and configured to dampen translational motion of the first body toward the second body in response to movement of the linear suspension actuator relative to the body.

In some implementations of the joint assembly, the arcuate configuration of the first surface of the first body and the arcuate configuration of the second surface of the second body are at least partially spherical.

In some implementations of the joint assembly, the arcuate configuration of the first surface of the first body is at least partially convex and the arcuate configuration of the second surface of the second body is at least partially concave, with the first surface received by the second surface.

In some implementations of the joint assembly, the damper is coupled to the second body.

In some implementations of the joint assembly, the joint assembly further includes a fastener. The second body defines a hole. The fastener extends through the hole and engages the first body to couple the first body with the second body.

In some implementations of the joint assembly, the first body defines an aperture with the fastener extending through aperture and being configured to engage the linear suspension actuator to couple the first body to the linear suspension actuator.

In some implementations of the joint assembly, the second body has an outer surface opposite the second surface with the hole extending between the second surface and the outer surface. The damper is molded to the second body and extending through the hole. A first portion of the damper is disposed along the second surface of the second body and a second portion of the damper is disposed along the outer surface of the second body.

In some implementations of the joint assembly, the joint assembly further includes a retention body, with the second body disposed between the first body and the retention body. The second portion of the damper is disposed between the second body and the retention body. The retention body abuts the second portion of the damper to dampen translational motion of the first body away from the second body in response to the movement of the linear suspension actuator relative to the body.

In some implementations of the joint assembly, the fastener engages the retention body and compresses the damper between the retention body and the second body.

In some implementations of the joint assembly, the retention body defines a bore and the first body includes a stem extending through the hole of the second body, with the bore of the retention body configured to receive the stem such that the stem supports the retention body, and with the fastener extending into the stem to couple the retention body to the stem.

In some implementations of the joint assembly, the second body includes a flange and studs extending from the flange and configured to engage the body of the vehicle to couple the second body to the body.

Another aspect of the disclosure is a joint assembly for coupling a linear suspension actuator to a body of a vehicle. The joint assembly includes a first member configured to be fixed to one of the linear suspension actuator or the body and a second member configured to be fixed to the other one of the linear suspension actuator or the body. The first member is coupled with the second member and rotatable relative to the second member within a first angle of rotation about a first axis, within a second angle of rotation about a second axis that is orthogonal to the first axis, and within a third angle of rotation about a third axis that is orthogonal to both the first axis and the second axis. The first member includes a protrusion. The second member includes a first wall and a second wall disposed on opposed sides of the protrusion, with the protrusion configured to contact the first wall or the second wall when the first member rotates relative to the second member about the first axis to retain the first member and the second member within the first angle of rotation. The first angle of rotation is less than the second angle of rotation and the first angle of rotation is less than the third angle of rotation.

In some implementations of the joint assembly, the first wall and the second wall at least partially define a gap for receiving the protrusion, with the protrusion movable within the gap as the first member rotates relative to the second member.

In some implementations of the joint assembly, the gap is configured such that the second member defines a void between the first wall and the second wall and above the protrusion to facilitate rotation of the first member relative to the second member about the second axis and the third axis.

In some implementations of the joint assembly, the first member includes more than one of the protrusion, with at least one of the protrusions disposed along the second axis and at least one of the protrusions disposed along the third axis. The second member includes more than one of the first wall and more than one of the second wall defining more than one of the gap individually corresponding with the protrusions, with at least one of the gaps disposed along the second axis and at least one of the gaps disposed along the third axis. The protrusion disposed along the third axis is arranged to translate within the gap disposed along the third axis as the first member rotates about the second axis relative to the second member. The protrusion disposed along the second axis is arranged to translate within the gap disposed along the second axis as the first member rotates about the third axis relative to the second member.

In some implementations of the joint assembly, the protrusion includes a first side surface adjacent the first wall of the second member and a second side surface adjacent the second wall of the second member, with the first side surface and the second side surface being substantially planar and arranged parallel to one another.

In some implementations of the joint assembly, the second member includes a second body and a damper, with the second body supporting the damper and with the damper including the first wall and the second wall.

In some implementations of the joint assembly, the damper is configured to deflect when the protrusion abuts the first wall or the second wall, with the deflection of the damper defining the first angle of rotation.

Another aspect of the disclosure is a joint assembly for coupling a linear suspension actuator to a body of a vehicle. The joint assembly includes a first body having a first surface and configured to be fixed to one of the linear suspension actuator or the body and a second body configured to be fixed to the other one of the linear suspension actuator or the body, with the second body having a second surface facing the first surface of the first body, an outer surface opposite the second surface, and further defining a hole extending between the second surface and the outer surface. The first body is rotatable relative to the second body about a first axis, a second axis that is orthogonal to the first axis, and a third axis that is orthogonal to both the first axis and the second axis. The joint assembly also includes a damper molded to the second body and extending through the hole, with a first portion of the damper disposed along the second surface of the second body and with a second portion of the damper disposed along the outer surface of the second body. The joint assembly also includes a retention body, with the second body disposed between the first body and the retention body. The retention body abuts the second portion of the damper. The first portion of the damper is disposed between the first body and the second body and is configured to dampen translational motion of the first body toward the second body in response to movement of the linear suspension actuator relative to the body. The second portion of the damper is disposed between the second body and the retention body and is configured to dampen translational motion of the first body away from the second body in response to movement of the linear suspension actuator relative to the body.

In some implementations of the joint assembly, the joint assembly further includes a fastener extending through the hole and engaging both the first body and the retention body, with the fastener compressing the damper between the retention body and the second body and coupling the first body with the second body.

### BRIEF DESCRIPTION OF THE DRAWINGS

FIG. 1 is a schematic front view illustration of a vehicle that includes a body, a linear suspension actuator, and a joint assembly.

FIG. 2 is a perspective view illustration of an example implementation of the joint assembly.

FIG. 3 is an exploded view illustration of the joint assembly of FIG. 2.

FIG. 4 is a side cross-sectional view illustration of the joint assembly of FIG. 2, taken along line 4-4.

FIG. 5 is a side cross-sectional view illustration of the joint assembly of FIG. 2, taken along line 5-5.

FIG. 6 is a top cross-sectional view illustration of the joint assembly of FIG. 2, taken along line 6-6.

FIG. 7 is perspective view illustration of an example implementation of the joint assembly.

### DETAILED DESCRIPTION

This disclosure is directed to joint assemblies for use in a vehicle. As an example, the joint assemblies that are described herein may be applicable within suspension assemblies of a vehicle. The suspension assembly may include a linear suspension actuator that extends between a wheel of the vehicle and a body of the vehicle. The linear suspension actuator may be an active suspension assembly that provides positive and negative displacement of the wheel relative to the body (i.e., jounce and rebound) or a passive suspension assembly that biases and dampens the movement of the body relative to the wheel. The joint assemblies described herein couple the linear suspension actuator to the body.

The movement of the wheel relative to the body as the vehicle drives along a road surfaces results in articulation of the linear suspension actuator relative to the body. The joint assembly rotates to accommodate the articulation of the linear suspension actuator. However, unrestricted rotation of the joint assembly may cause adverse vehicle dynamic events, such as wheel-hop (i.e., unintended vertical movement of the wheel) and vibration. On the other hand, the excessive rotational restrictions may exert excessive forces on the linear suspension actuator that can damage the linear suspension actuator. The joint assemblies described herein provide selective rotation to facilitate articulation of the linear suspension actuator relative to the body and dampen vibrations from the movement of the wheels to provide comfortable ride quality.

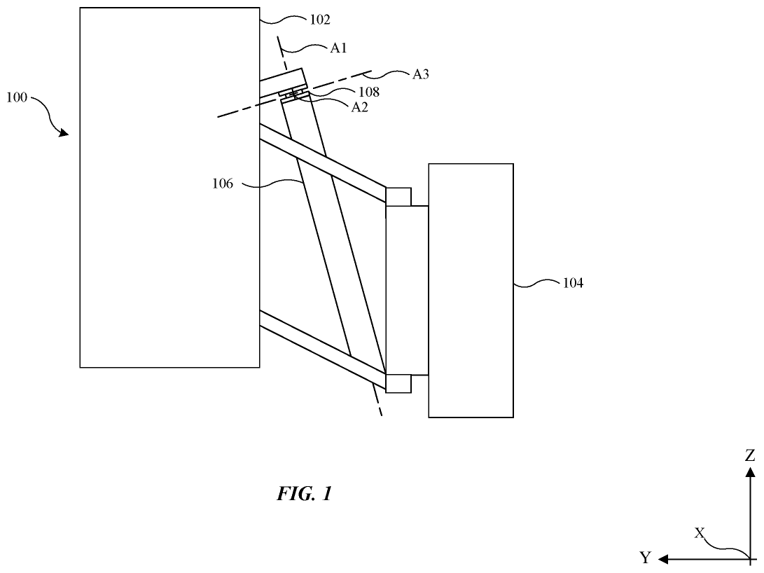

FIG. 1 is a schematic front view illustration of a vehicle 100. The vehicle 100 includes a body 102. The body 102 may define a passenger compartment for carrying passengers. The vehicle 100 will be described with reference to a longitudinal direction X (e.g., fore-aft), a lateral direction Y (e.g., side to side), and an elevational direction Z (e.g., up-down). The vehicle 100 may be a road-going vehicle that is able to travel freely upon roadways and other surfaces. The vehicle 100 includes a wheel 104 that is coupled to and supports the body 102. Although the wheel 104 is shown singly, the vehicle 100 may utilize multiple wheels (e.g., four wheels, such as two front wheels and two rear wheels).

The vehicle 100 includes a linear suspension actuator 106 disposed at the wheel 104 (e.g., four linear suspension actuators individually disposed at the four wheels). The vehicle 100 includes a joint assembly 108 for coupling the linear suspension actuator 106 to the body 102. The linear suspension actuator 106 translates to control vertical motion of the wheel 104 relative to the body 102, for example, to ensure contact between the wheel 104 and a surface of the roadway and to limit the influence of roadway conditions on undesirable movements of the body 102. The linear suspension actuator 106 may be an active suspension assembly that includes an elongated member and an electric device (such as motor, servo, solenoid, etc.) that translates the elongated member to provide positive and negative displacement of the wheel 104 relative to the body 102. More specifically, the linear suspension actuator 106 may move the wheel 104 up and down relative to the body 102. Alternatively, the linear suspension actuator 106 may be a passive suspension assembly that includes a spring for biasing the body 102 relative to the wheel 104 and a shock absorber for damping the movement of the body 102 relative to the wheel 104. It is appreciated that the linear suspension actuator 106 may have any suitable configuration for facilitate movement of the wheel 104 relative to the body 102.

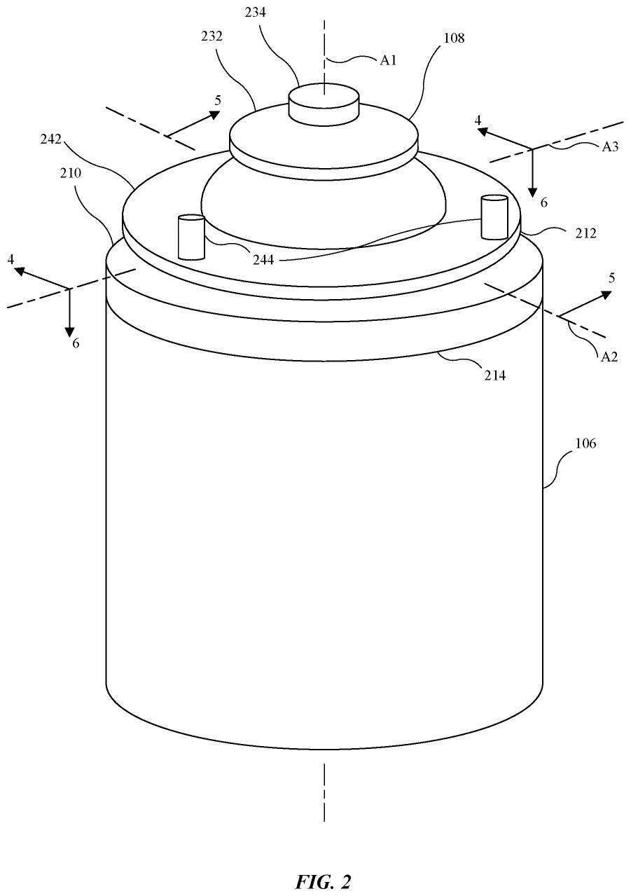

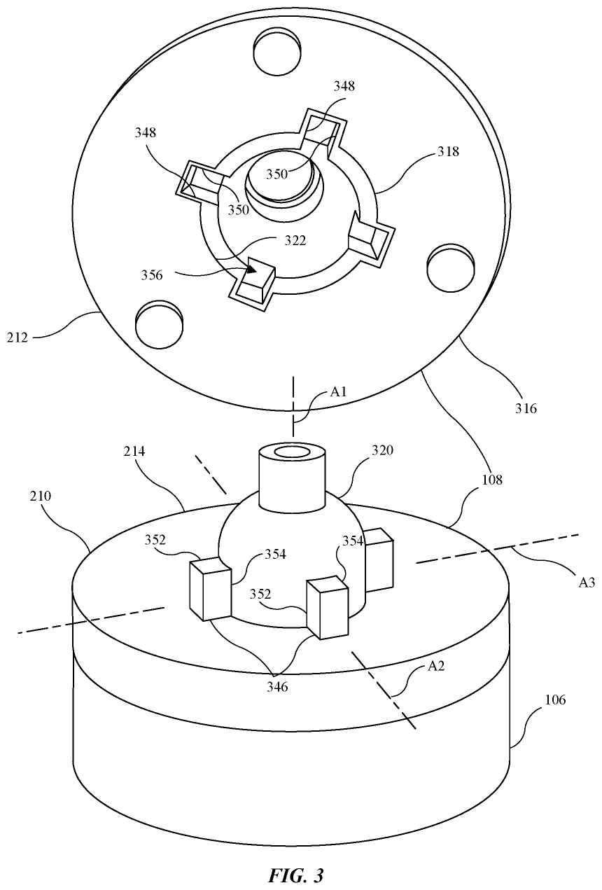

FIG. 2 is a perspective view illustration of an example implementation of the joint assembly 108. The joint assembly 108 includes a first member 210 configured to be fixed to one of the linear suspension actuator 106 or the body 102 and a second member 212 configured to be fixed to the other one of the linear suspension actuator 106 or the body 102. The first member 210 includes a first body 214. FIG. 3 is an exploded view illustration of the joint assembly 108 showing the second member 212 including a second body 316 and a damper 318. The first body 214 has a first surface 320 and is configured to be fixed to one of the linear suspension actuator 106 or the body 102. Said differently, the first body 214 has a first surface 320 and is configured to be fixed to either the linear suspension actuator 106 or the body 102. The second body 316 has a second surface 322 and configured to be fixed to the other one of the linear suspension actuator 106 or the body 102. The second surface 322 faces the first surface 320 of the first body 214. In the implementation shown in FIG. 2, the first member 210 (more specifically, the first body 214) is fixed to the linear suspension actuator 106. The second member 212 (more specifically, the second body 316) is configured to be fixed to the body 102. However, the first member 210 and the first body 214 may fixed to the body 102 and the second member 212 and the second body 316 may be fixed to the linear suspension actuator 106.

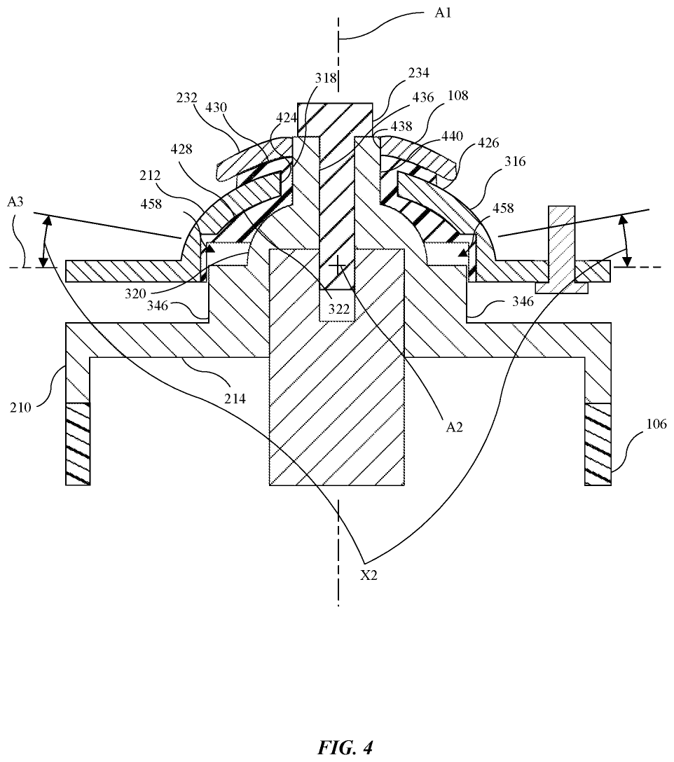

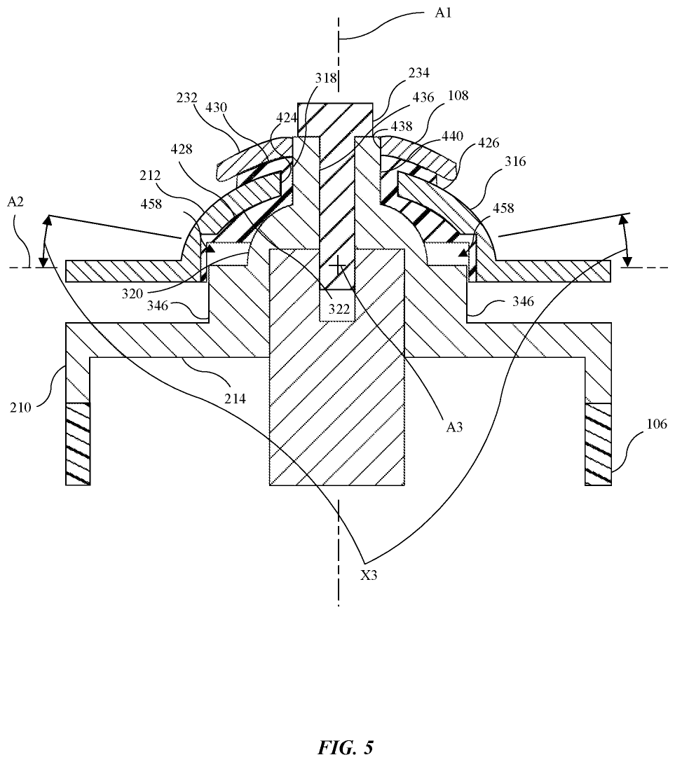

FIGS. 4 and 5 are side cross-sectional view illustrations of the joint assembly 108 that show the first body 214 is coupled with the second body 316. The first surface 320 and the second surface 322 have arcuate configurations that are complementary to facilitate rotation of the first body 214 relative to the second body 316. More specifically, the first body 214 is rotatable relative to the second body 316 about a first axis A1, a second axis A2, orthogonal to the first axis A1, and a third axis A3, orthogonal to both the first axis A1 and the second axis A2, as shown in FIG. 2. Because the first member 210 is configured to be fixed to one of the linear suspension actuator 106 or the body 102 and the second member 212 is configured to be fixed to the other one of the linear suspension actuator 106 or the body 102, the rotation of the first body 214 relative to the second body 316 may allow movement of the linear suspension actuator 106 relative to the body 102 at the joint assembly 108, which accommodates the movement of the wheel 104 relative to the body 102. As shown in FIG. 1, the first axis A1 extends longitudinally through the linear suspension actuator 106 and the joint assembly 108. The second axis A2 is shown in FIG. 1 as extending generally longitudinally along the vehicle 100 between the front and rear of the vehicle 100. The third axis A3 is shown in FIG. 1 as extending generally laterally across the vehicle 100 between the left side and the right side of the vehicle 100. The first axis A1, the second axis A2, and the third axis A3 may be disposed in any suitable position relative to the linear suspension actuator 106 and the body 102 of the vehicle 100.

As shown in FIGS. 4 and 5, the joint assembly 108 also includes the damper 318 disposed between the first body 214 and the second body 316 and configured to dampen translational motion of the first body 214 toward the second body 316 in response to movement of the linear suspension actuator 106 relative to the body 102. The damper 318 reduces vibrations caused by the movement of the wheel 104 and the linear suspension actuator 106 from transferring to the body 102, which can fatigue structural components within the vehicle 100 and be unfavorably felt by passengers of the vehicle 100. The damper 318 also absorbs excess loads to prevent direct contact between the first body 214 and the second body 316, while allowing the rotation between the first body 214 and the second body 316. The damper 318 may comprise an elastomer or any other suitable material for damping motion and vibration.

The arcuate configuration of the first surface 320 of the first body 214 and the arcuate configuration of the second surface 322 of the second body 316 are at least partially spherical. Furthermore, the arcuate configuration of the first surface 320 of the first body 214 is at least partially convex and the arcuate configuration of the second surface 322 of the second body 316 is at least partially concave, with the first surface 320 received by the second surface 322. More specifically, the first body 214 and the second body 316 form a ball-and-socket configuration allowing rotation of the first body 214 relative to the second body 316 about the first axis A1, the second axis A2, and the third axis A3. However, the arcuate configuration of the first surface 320 of the first body 214 may be at least partially concave and the arcuate configuration of the second surface 322 of the second body 316 may be at least partially convex. Furthermore, the arcuate configuration of the first surface 320 and the arcuate configuration of the second surface 322 may have any suitable shape for facilitating rotation between the first body 214 and the second body 316.

The second body 316 defines a hole 424. More specifically, the second body 316 has an outer surface 426 opposite the second surface 322 with the hole 424 extending between the second surface 322 and the outer surface 426. The hole 424 is substantially centered on the second body 316 and extends along the first axis A1. However, the hole 424 may be positioned at any suitable location on the second body 316 and in any suitable configuration.

The damper 318 is coupled to the second body 316. More specifically, the damper 318 is molded to the second body 316 and extends through the hole 424. As such, the damper 318 is disposed on two sides of the second body 316. A first portion 428 of the damper 318 is disposed along the second surface 322 of the second body 316 and a second portion 430 of the damper 318 is disposed along the outer surface 426 of the second body 316. Although the damper 318 is shown as molded to the second body 316, the damper 318 may be coupled to the second body 316 in any suitable manner, including (but not limited to) fasteners and chemical adhesion. Furthermore, the damper 318 is shown as a single component. However, the damper 318 may include multiple components that are adjacent or spaced from one another.

The first portion 428 of the damper 318 is disposed between the first body 214 and the second body 316 and is configured to dampen translational motion of the first body 214 toward the second body 316 in response to movement of the linear suspension actuator 106 relative to the body 102. More specifically, movement of the first body 214 toward the second body 316 in the implementation shown in the Figures occurs when the wheel 104 is moved upwardly toward the body 102 (either actively by linear suspension actuator 106 or passively by the contact between the wheel 104 and the road surface causing suspension jounce). The movement of the first body 214 toward the second body 316 compresses the first portion 428 of the damper 318 disposed therebetween. The first portion 428 of the damper 318 dampens the translational motion, vibration, etc. associated with the upward movement of the wheel 104.

As shown in FIG. 2, the joint assembly 108 further includes a retention body 232, with the second body 316 disposed between the first body 214 and the retention body 232. The retention body 232 is fixed to the first body 214, which will be described in greater detail below. The second body 316 is retained to the first body 214 retention body 232. As shown in FIGS. 4 and 5, the second portion 430 of the damper 318 is disposed between the second body 316 and the retention body 232. The retention body 232 abuts the second portion 430 of the damper 318 to dampen translational motion of the first body 214 away from the second body 316 in response to the movement of the linear suspension actuator 106 relative to the body 102. More specifically, movement of the first body 214 away from the second body 316 in the implementation shown in the Figures occurs when the wheel 104 is moved downwardly away from the body 102 (either actively by linear suspension actuator 106 or passively by elongation of the spring due to suspension rebound). Because the retention body 232 is fixed to the first body 214, movement of the first body 214 away from the second body 316 compresses the second portion 430 of the damper 318 between the second body 316 and the retention body 232. The second portion 430 of the damper 318 dampens the translational motion, vibration, etc. associated with the downward movement of the wheel 104.

As shown in FIG. 2, the joint assembly 108 further includes a fastener 234. The fastener 234 extends through the hole 424 and engages the first body 214 to couple the first body 214 with the second body 316, as shown in FIGS. 4 and 5. More specifically, the first body 214 defines an aperture 436. The fastener 234 extends through aperture 436. The fastener 234 is configured to engage the linear suspension actuator 106 to couple the first body 214 to the linear suspension actuator 106. The retention body 232 defines a bore 438 and the first body 214 includes a stem 440 extending through the hole 424 of the second body 316. The bore 438 of the retention body 232 is configured to receive the stem 440 such that the stem 440 supports the retention body 232, and with the fastener 234 extending into the stem 440 to couple the retention body 232 to the stem 440. The fastener 234 engages the retention body 232 and compresses the damper 318 between the retention body 232 and the second body 316 and couples the first body 214 with the second body 316. More specifically, the stem 440 of the first body 214 extends through the hole 424 of the second body 316 and into engagement with the retention body 232 within the bore 438. The stem 440 disposed within the hole 424 of the second body 316 retains the second body 316 laterally relative to the first axis A1. The second body 316 and the damper 318 are positioned between the first body 214 and the retention body 232 along the first axis A1. The fastener 234 secures the retention body 232 against the stem 440 of the first body 214 secures the first body 214 to the linear suspension actuator 106. The first body 214 and the retention body 232 serve as end stops for the second body 316 and the damper 318 along the first axis A1, preventing removal of the second body 316 and the damper 318 from the joint assembly 108. The hole 424 of the second body 316 has a diameter that is larger than a diameter of the stem 440, allowing the first body 214 to rotate relative to the second body 316 about the second axis A2 and the third axis A3. The second body 316 may also rotate about the stem 440 along the first axis A1.

As shown in FIG. 2, the second body 316 includes a flange 242. The flange 242 extends radially from the first axis A1. The second body 316 also includes studs 244 extending from the flange 242. The studs 244 extends away from the first body 214. The studs 244 configured to engage the body 102 of the vehicle 100 to couple the second body 316 to the body 102 of the vehicle 100.

The rotation of the first member 210 relative to the second member 212 may allow movement of the linear suspension actuator 106 relative to the body 102 of the vehicle 100 at the joint assembly 108, which accommodates the movement of the wheel 104 relative to the body 102. However, rotation of the first member 210 relative to the second member 212 may not be unlimited. Moreover, the amount of rotation between the first member 210 and the second member 212 may vary between the first axis A1, the second axis A2, and the third axis A3.

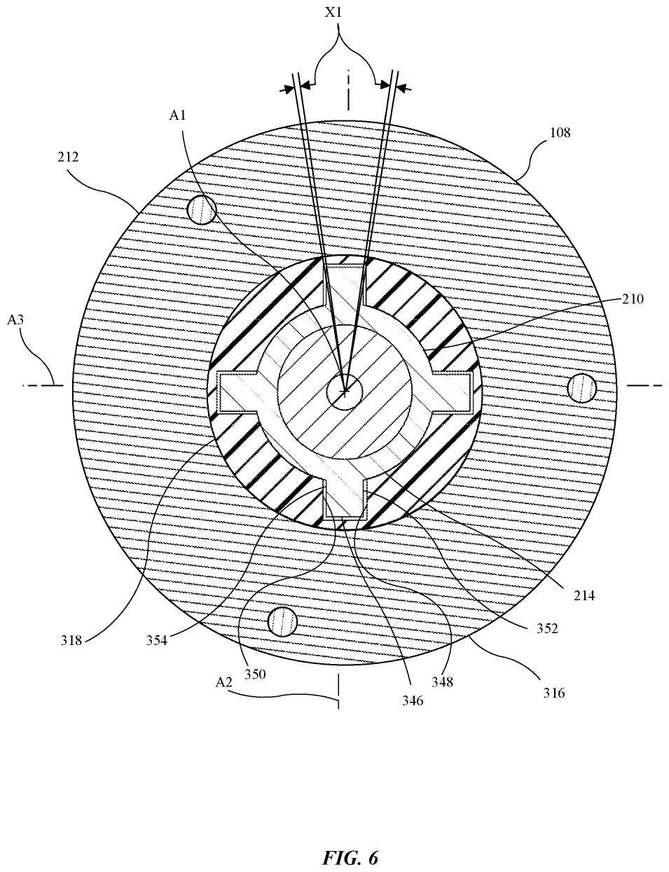

For example, with the linear suspension actuator 106 configured as the active suspension assembly, the electric device may rotate and about the first axis A1 to translate the elongated member along the first axis A1 and move the wheel 104 up and down. The inertia of the rotating electric device creates torsional reactions loads at the joint assembly 108. To prevent wheel-hop and the corresponding vibration of wheel-hop, the torsional resonance of the linear suspension actuator 106 and the joint assembly 108 (i.e., the rotational resonance of the linear suspension actuator 106 and the joint assembly 108 about the first axis A1) must be greater than the frequency of the wheel-hop. The torsional stiffness of the joint assembly 108 must accommodate the desired torsional resonance. The torsional stiffness may be defined in-part by the range of rotation between the first member 210 and the second member 212 about the first axis A1. More specifically, the first member 210 is coupled with the second member 212 and rotatable relative to the second member 212 within a first angle of rotation X1 about the first axis A1, as illustrated in the top cross-sectional view illustration of the joint assembly 108 shown in FIG. 6. In one example, the first angle of rotation X1 is two degrees. In another example, the first angle of rotation X1 is one degree. In another example, the first angle of rotation X1 is 0.6 degree. It is to be appreciated that the first angle of rotation X1 may be any suitable value.

With the linear suspension actuator 106 configured as the active suspension assembly, the components of the linear suspension actuator 106 (including the electric device and the elongated member) may be sensitive to bending loads (i.e., deflection of the linear suspension actuator 106 from the first axis A1). The conical stiffness of the joint assembly 108 must accommodate the bending loads exerted on the linear suspension actuator 106 during operation of the vehicle 100 along the road surface. The conical stiffness may be defined in-part by the range of rotation between the first member 210 and the second member 212 about the second axis A2 or the range of rotation between the first member 210 and the second member 212 about the third axis A3. More specifically, the first member 210 is coupled with the second member 212 and rotatable relative to the second member 212 within a second angle of rotation X2 (as shown in FIG. 4) about the second axis A2 that is orthogonal to the first axis A1, and within a third angle of rotation X3 (as shown in FIG. 5) about the third axis A3 that is orthogonal to both the first axis A1 and the second axis A2. In one example, the second angle of rotation X2 is 20 degrees. In another example, the second angle of rotation X2 is 10 degrees. In another example, the second angle of rotation X2 is five degrees. It is to be appreciated that the second angle of rotation X2 may be any suitable value. In one example, the third angle of rotation X3 is 20 degrees. In another example, the third angle of rotation X3 is 10 degrees. In another example, the third angle of rotation X3 is five degrees. It is to be appreciated that the third angle of rotation X3 may be any suitable value. The first angle of rotation X1 is less than the second angle of rotation X2 and the first angle of rotation X1 is less than the third angle of rotation X3. As such, the torsional stiffness of the joint assembly 108 is greater than the conical stiffness of the joint assembly 108.

To define the first angle of rotation X1, the second angle of rotation X2, and the third angle of rotation X3, the first member 210 includes a protrusion 346, as shown in FIG. 3. The second member 212 includes a first wall 348 and a second wall 350 disposed on opposed sides of the protrusion 346, with the protrusion 346 configured to contact the first wall 348 or the second wall 350 when the first member 210 rotates relative to the second member 212 about the first axis A1 to retain the first member 210 and the second member 212 within the first angle of rotation X1. More specifically, in one implementation rotation of the first member 210 relative to the second member 212 about the first axis A1 in a first rotational direction will bring the protrusion 346 into contact with the first wall 348. Rotation of the first member 210 relative to the second member 212 about the first axis A1 in a second rotational direction, opposite the first rotational direction, will bring the protrusion 346 into contact with the second wall 350. In another implementation, rotation of the first member 210 relative to the second member 212 about the first axis A1 in the first rotational direction will bring the protrusion 346 into contact with the second wall 350. Rotation of the first member 210 relative to the second member 212 about the first axis A1 in a second rotational direction, opposite the first rotational direction, will bring the protrusion 346 into contact with the first wall 348. The protrusion 346 includes a first side surface 352 adjacent the first wall 348 of the second member 212 and a second side surface 354 adjacent the second wall 350 of the second member 212, with the first side surface 352 and the second side surface 354 being substantially planar and arranged parallel to one another. However, the first side surface 352 and the second side surface 354 may be non-planar (including arcuate, compound angular surfaces, combinations of arcuate and compound angular surfaces, etc.). Furthermore, the first side surface 352 and the second side surface 354 may be disposed any suitable position relative to one another to facilitate contact with the first wall 348 and the second wall 350, respectively.

The first wall 348 and the second wall 350 at least partially define a gap 356 for receiving the protrusion 346, with the protrusion 346 movable within the gap 356 as the first member 210 rotates relative to the second member 212. As shown in FIGS. 4 and 5, the gap 356 is configured such that the second member 212 defines a void 458 between the first wall 348 and the second wall 350 and above the protrusion 346 to facilitate rotation of the first member 210 relative to the second member 212 about the second axis A2 and the third axis A3. The second member 212 extends across the first wall 348 and the second wall 350 such that the second member 212 defines the void 458. The protrusion 346 moves into and out of the void 458 as the first member 210 rotates relative to the second member 212 about the second axis A2 or the third axis A3.

As shown in FIG. 3, the second body 316 supports the damper 318 and the damper 318 includes the first wall 348 and the second wall 350. Moreover, the damper 318 defines the gap 356 and the void 458. However, the second body 316 could include the first wall 348 and the second wall 350.

In the implementation shown in FIG. 3, the first member 210 includes more than one of the protrusion 346, with at least one of the protrusions 346 disposed along the second axis A2 and at least one of the protrusions 346 disposed along the third axis A3. More specifically, the first member 210 includes two of the protrusion 346 disposed along the second axis A2, mirroring one another across the first axis A1. The first member 210 also includes two of the protrusion 346 disposed along the third axis A3, mirroring one another across the first axis A1. It is to be appreciated that any number of protrusions 346 may be utilized and at any suitable location on the first member 210.

The second member 212 includes more than one of the first wall 348 and more than one of the second wall 350 defining more than one of the gap 356 individually corresponding with the protrusions 346, with at least one of the gaps 356 disposed along the second axis A2 and at least one of the gaps 356 disposed along the third axis A3. More specifically, the second member 212 includes two pairs of the first wall 348 and the second wall 350 disposed along the second axis A2, with one pair of the first wall 348 and the second wall 350 disposed on one side of second member 212 and with the other pair of the first wall 348 and the second wall 350 mirrored across the first axis A1 on another side of the second member 212. The second member 212 also includes two pairs of the first wall 348 and the second wall 350 disposed along the third axis A3, with one pair of the first wall 348 and the second wall 350 disposed on one side of second member 212 and with the other pair of the first wall 348 and the second wall 350 mirrored across the first axis A1 on another side of the second member 212. It is to be appreciated that any number of first walls 348 and second walls 350 may be utilized and at any suitable location on the second member 212.

The one or more protrusions 346 disposed along the third axis A3 are arranged to translate within the respective one or more gaps 356 disposed along the third axis A3 as the first member 210 rotates about the second axis A2 relative to the second member 212. As shown in FIG. 4, the two protrusions 346 disposed along the third axis A3 are arranged to translate within the two gaps 356, respectively, as the first member 210 rotates about the second axis A2 relative to the second member 212. Rotation of the first member 210 relative to the second member 212 about the second axis A2 in a first rotational direction will move one of the two protrusions 346 up and into the corresponding void 458 and the other one of the two protrusions 346 down and out of the corresponding void 458. The first member 210 rotates relative to the second member 212 about the second axis A2 until the protrusion 346 moving into the void 458 progresses fully across the void 458 and into contact with the second member 212. Similarly, rotation of the first member 210 relative to the second member 212 about the second axis A2 in a second rotational direction, opposite the first rotational direction, will move the other one of the two protrusions 346 up and into the corresponding void 458. Likewise, the first member 210 rotates relative to the second member 212 about the second axis A2 until the protrusion 346 moving into the void 458 progresses fully across the void 458 and into contact with the second member 212. More specifically, in one implementation, rotation of the first member 210 relative to the second member 212 about the second axis A2 in the first rotational direction moves the protrusion 346 on the left side of the first member 210 in FIG. 4 up and into the corresponding void 458 and the protrusion 346 on the right side of the first member 210 down and out of the corresponding void 458. Rotation of the first member 210 relative to the second member 212 about the second axis A2 in the second rotational direction moves the protrusion 346 on the right side of the first member 210 up and into the corresponding void 458 and the protrusion 346 on the left side of the first member 210 down and out of the corresponding void 458. In another implementation, rotation of the first member 210 relative to the second member 212 about the second axis A2 in the first rotational direction moves the protrusion 346 on the right side of the first member 210 in FIG. 4 up and into the corresponding void 458 and the protrusion 346 on the left side of the first member 210 down and out of the corresponding void 458. Rotation of the first member 210 relative to the second member 212 about the second axis A2 in the second rotational direction moves the protrusion 346 on the left side of the first member 210 up and into the corresponding void 458 and the protrusion 346 on the right side of the first member 210 down and out of the corresponding void 458.

The rotation of the first member 210 relative to second member 212 about the second axis A2 until rotation is stopped by contact between the first member 210 and the second member 212 defines the second angle of rotation X2. More specifically, the rotation of the first member 210 relative to second member 212 about the second axis A2 occurs until rotation is stopped by contact of the protrusions 346 along the third axis A3 with the second member 212 within the corresponding voids 458, defining the second angle of rotation X2. However, the protrusions 346 may move into and out of the corresponding voids 458 without the protrusions 346 contacting the second member 212. For example, another portion of the first member 210 (separate from the protrusions 346) may contact the second member 212 to define the second angle of rotation X2.

The one or more protrusions 346 disposed along the second axis A2 are arranged to translate within the respective one or more gaps 356 disposed along the second axis as the first member 210 rotates about the third axis A3 relative to the second member 212. As shown in FIG. 5, the two protrusions 346 disposed along the second axis A2 are arranged to translate within the two gaps 356, respectively, as the first member 210 rotates about the third axis A3 relative to the second member 212. Rotation of the first member 210 relative to the second member 212 about the third axis A3 in a first rotational direction will move one of the two protrusions 346 up and into the corresponding void 458 and the other one of the two protrusions 346 down and out of the corresponding void 458. The first member 210 rotates relative to the second member 212 about the third axis A3 until the protrusion 346 moving into the void 458 progresses fully across the void 458 and into contact with the second member 212. Similarly, rotation of the first member 210 relative to the second member 212 about the third axis A3 in a second rotational direction, opposite the first rotational direction, will move the other one of the two protrusions 346 up and into the corresponding void 458. Likewise, the first member 210 rotates relative to the second member 212 about the third axis A3 until the protrusion 346 moving into the void 458 progresses fully across the void 458 and into contact with the second member 212. More specifically, in one implementation, rotation of the first member 210 relative to the second member 212 about the third axis A3 in the first rotational direction moves the protrusion 346 on the left side of the first member 210 in FIG. 5 up and into the corresponding void 458 and the protrusion 346 on the right side of the first member 210 down and out of the corresponding void 458. Rotation of the first member 210 relative to the second member 212 about the third axis A3 in the second rotational direction moves the protrusion 346 on the right side of the first member 210 up and into the corresponding void 458 and the protrusion 346 on the left side of the first member 210 down and out of the corresponding void 458. In another implementation, rotation of the first member 210 relative to the second member 212 about the third axis A3 in the first rotational direction moves the protrusion 346 on the right side of the first member 210 in FIG. 5 up and into the corresponding void 458 and the protrusion 346 on the left side of the first member 210 down and out of the corresponding void 458. Rotation of the first member 210 relative to the second member 212 about the third axis A3 in the second rotational direction moves the protrusion 346 on the left side of the first member 210 up and into the corresponding void 458 and the protrusion 346 on the right side of the first member 210 down and out of the corresponding void 458.

The rotation of the first member 210 relative to second member 212 about the third axis A3 until rotation is stopped by contact between the first member 210 and the second member 212 defines the second angle of rotation X2. More specifically, the rotation of the first member 210 relative to second member 212 about the third axis A3 occurs until rotation is stopped by contact of the protrusions 346 along the second axis A2 with the second member 212 within the corresponding voids 458, defining the third angle of rotation X3. However, the protrusions 346 may move into and out of the corresponding voids 458 without the protrusions 346 contacting the second member 212. For example, another portion of the first member 210 (separate from the protrusions 346) may contact the second member 212 to define the second angle of rotation X2.

As described above, the damper 318 may comprise an elastomer or any other suitable material for damping motion and vibration. As such, the damper 318 is configured to deflect when the protrusion 346 abuts the first wall 348 or the second wall 350, with the deflection of the damper 318 defining the first angle of rotation X1. Furthermore, engagement of the protrusion 346 with the damper 318 that occurs when the first member 210 rotates relative to the second member 212 about the second axis A2 or the third axis A3 may cause deflection of the damper 318. As such, deflection of the damper 318 may also define the second angle of rotation X2 and the third angle of rotation X3. While the first angle of rotation X1 shown in FIG. 6, the second angle of rotation X2 shown in FIG. 4, and the third angle of rotation X3 shown in FIG. 5 illustrate contact rotation until contact between the first member 210 and the second member 212, deflection of the damper 318 may occur causing one or more of the first angle of rotation X1, the second angle of rotation X2, and the third angle of rotation X3 to be larger than illustrated.

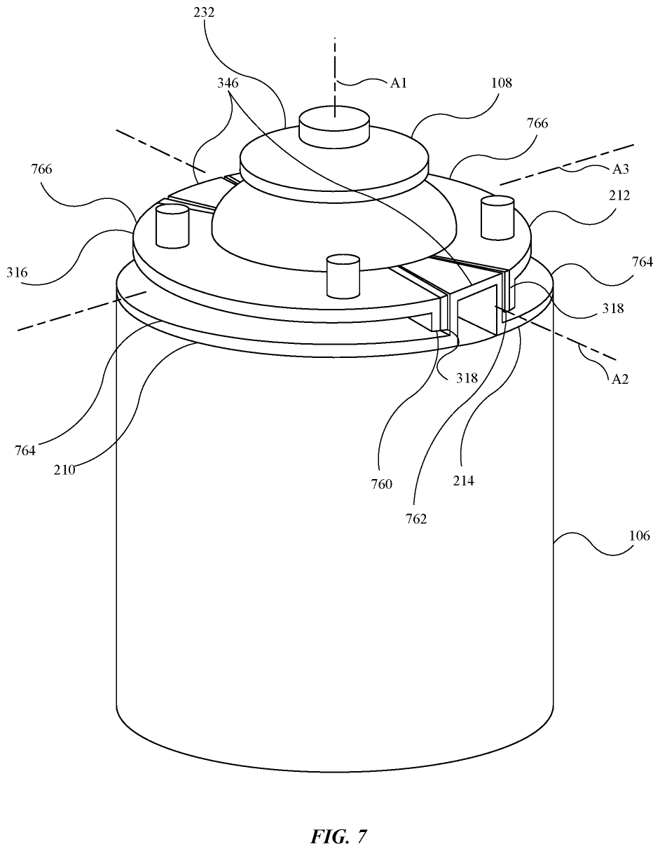

FIG. 7 is a perspective view illustration of another example implementation of the joint assembly 108. The damper 318 includes multiple components that are separate from one another. For example, the damper 318 has separate components along the first walls 348 and the second walls 350 for contacting the protrusions 346 of the first member 210.

The first member 210 includes two of the protrusion 346 disposed along the third axis A3. The second member 212 includes two pairs of the first wall 348 and the second wall 350 disposed along the third axis A3. The first walls 348 extend down toward the first member 210 and truncate at a first contact surface 760. The second walls 350 extend down toward the second member 212 and truncate at a second contact surface 762. The second member 212 does not extend across the first wall 348 and the second wall 350 and define the void 458. As such rotation of the first member 210 relative to the second member 212 about the second axis A2 causes the protrusions 346 to rotate up into the voids 458 without the protrusions 346 contacting the second member 212. Instead, rotation of the first member 210 relative to the second member 212 about the second axis A2 causes the first contact surfaces 760 and the second contact surface 762 to move down and into contact with the first member 210, defining the second angle of rotation X2.

The implementation shown in FIG. 7 omits the protrusions 346, the first walls 348, and the second walls 350 disposed along the second axis A2. Instead, the first body 214 of the first member 210 includes a pair of first lips 764 extending between the protrusions 346 disposed along the third axis A3. The second body 316 of the second member 212 includes a pair of second lips 766 extending between the first and second gaps 356 disposed along the third axis A3. Rotation of the first member 210 relative to the second member 212 about the third axis A3 causes the first lips 764 of the first body 214 to contact the second lips 766 of the second body 316 and define the third angle of rotation X3.

As described above, one aspect of the present technology is the gathering and use of data available from various sources for use in controlling a vehicle. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores user preference related information that allows operation of a device according to user preferences. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, information may be determined each time the system is used, and without subsequently storing the information or associating with the particular user.

What is claimed is:

1. A joint assembly for coupling a linear suspension actuator to a body of a vehicle, the joint assembly comprising:
a first body having a first surface and configured to be fixed to one of the linear suspension actuator or the body;
a second body having a second surface and configured to be fixed to the other one of the linear suspension actuator or the body, with the first body coupled with the second body and with the first surface and the second surface having arcuate configurations that are complementary to facilitate rotation of the first body relative to the second body about a first axis, a second axis, orthogonal to the first axis, and a third axis, orthogonal to both the first axis and the second axis; and
a damper disposed between the first body and the second body and configured to dampen translational motion of the first body toward the second body in response to movement of the linear suspension actuator relative to the body.

2. The joint assembly of claim 1, wherein the arcuate configuration of the first surface of the first body and the arcuate configuration of the second surface of the second body are at least partially spherical.

3. The joint assembly of claim 1, wherein the arcuate configuration of the first surface of the first body is at least partially convex and the arcuate configuration of the second surface of the second body is at least partially concave, with the first surface received by the second surface.

4. The joint assembly of claim 1, wherein the damper is coupled to the second body.

5. The joint assembly of claim 1, further comprising a fastener and wherein the second body defines a hole, with the fastener extending through the hole and engaging the first body to couple the first body with the second body.

6. The joint assembly of claim 5, wherein the first body defines an aperture with the fastener extending through aperture and is configured to engage the linear suspension actuator to couple the first body to the linear suspension actuator.

7. The joint assembly of claim 5, wherein the second body has an outer surface opposite the second surface with the hole extending between the second surface and the outer surface, with the damper molded to the second body and extending through the hole, and with a first portion of the damper disposed along the second surface of the second body and with a second portion of the damper disposed along the outer surface of the second body.

8. The joint assembly of claim 7, further including a retention body, with the second body disposed between the first body and the retention body,
wherein the second portion of the damper is disposed between the second body and the retention body, and
wherein the retention body abuts the second portion of the damper to dampen translational motion of the first body away from the second body in response to the movement of the linear suspension actuator relative to the body.

9. The joint assembly of claim 8, wherein the fastener engages the retention body and compresses the damper between the retention body and the second body.

10. The joint assembly of claim 9, wherein the retention body defines a bore and the first body includes a stem extending through the hole of the second body, with the bore of the retention body configured to receive the stem such that the stem supports the retention body, and with the fastener extending into the stem to couple the retention body to the stem.

11. The joint assembly of claim 5, wherein the second body includes a flange and studs extending from the flange and configured to engage the body of the vehicle to couple the second body to the body.

12. A joint assembly for coupling a linear suspension actuator to a body of a vehicle, the joint assembly comprising:
a first member configured to be fixed to one of the linear suspension actuator or the body; and
a second member configured to be fixed to the other one of the linear suspension actuator or the body, with the first member coupled with the second member and rotatable relative to the second member within a first angle of rotation about a first axis, within a second angle of rotation about a second axis that is orthogonal to the first axis, and within a third angle of rotation about a third axis that is orthogonal to both the first axis and the second axis,
wherein the first member includes a protrusion,
wherein the second member includes a first wall and a second wall disposed on opposed sides of the protrusion, with the protrusion configured to contact the first wall or the second wall when the first member rotates relative to the second member about the first axis to retain the first member and the second member within the first angle of rotation, and
wherein the first angle of rotation is less than the second angle of rotation and the first angle of rotation is less than the third angle of rotation.

13. The joint assembly of claim 12, wherein the first wall and the second wall at least partially define a gap for receiving the protrusion, with the protrusion movable within the gap as the first member rotates relative to the second member.

14. The joint assembly of claim 13, wherein the gap is configured such that the second member defines a void between the first wall and the second wall and above the protrusion to facilitate rotation of the first member relative to the second member about the second axis and the third axis.

15. The joint assembly of claim 13, wherein the first member includes more than one of the protrusion, with at least one of the protrusions disposed along the second axis and at least one of the protrusions disposed along the third axis,
wherein the second member includes more than one of the first wall and more than one of the second wall defining more than one of the gap individually corresponding with the protrusions, with at least one of the gaps disposed along the second axis and at least one of the gaps disposed along the third axis,
wherein the protrusion disposed along the third axis is arranged to translate within the gap disposed along the third axis as the first member rotates about the second axis relative to the second member, and
wherein the protrusion disposed along the second axis is arranged to translate within the gap disposed along the second axis as the first member rotates about the third axis relative to the second member.

16. The joint assembly of claim 12, wherein the protrusion includes a first side surface adjacent the first wall of the second member and a second side surface adjacent the second wall of the second member, with the first side surface and the second side surface being substantially planar and arranged parallel to one another.

17. The joint assembly of claim 12, wherein the second member includes a second body and a damper, with the second body supporting the damper and with the damper including the first wall and the second wall.

18. The joint assembly of claim 17, wherein the damper is configured to deflect when the protrusion abuts the first wall or the second wall, with the deflection of the damper defining the first angle of rotation.

19. A joint assembly for coupling a linear suspension actuator to a body of a vehicle, the joint assembly comprising:
a first body having a first surface and configured to be fixed to one of the linear suspension actuator or the body;
a second body configured to be fixed to the other one of the linear suspension actuator or the body, with the second body having a second surface facing the first surface of the first body, an outer surface opposite the second surface, and further defining a hole extending between the second surface and the outer surface, wherein the first body is rotatable relative to the second body about a first axis, a second axis that is orthogonal to the first axis, and a third axis that is orthogonal to both the first axis and the second axis;
a damper molded to the second body and extending through the hole, with a first portion of the damper disposed along the second surface of the second body and with a second portion of the damper disposed along the outer surface of the second body; and
a retention body, with the second body disposed between the first body and the retention body,
wherein the retention body abuts the second portion of the damper,
wherein the first portion of the damper is disposed between the first body and the second body and is configured to dampen translational motion of the first body toward the second body in response to movement of the linear suspension actuator relative to the body, and
wherein the second portion of the damper is disposed between the second body and the retention body and is configured to dampen translational motion of the first body away from the second body in response to movement of the linear suspension actuator relative to the body.

20. The joint assembly of claim 19, further comprising a fastener extending through the hole and engaging both the first body and the retention body, with the fastener compressing the damper between the retention body and the second body and coupling the first body with the second body.
